(19) United States
(12) Patent Application Publication
(10) Pub. No.: US 2008/0048006 A1
(43) Pub. Date: Feb. 28, 2008

(54) WIRE BONDER

(75) Inventors: Chih-Ming Hung, Kaohsiung City (TW); Wen-Fu Chen, Kaohsiung City (TW); Yueh-Hsi Chen, Kaohsiung City (TW); Jen-Chin Liu, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ADVANCED SEMICONDUCTOR ENGINEERING, INC., Kaohsiung (TW)

(21) Appl. No.: 11/535,500

(22) Filed: Sep. 27, 2006

(30) Foreign Application Priority Data
Aug. 25, 2006 (TW) 95131320

(51) Int. Cl. A47J 36/02

(52) U.S. Cl. 228/101

(57) ABSTRACT

A wire bonder suitable for wire bonding a chip disposed on a carrier and bonding pads of the carrier is provided. The wire bonder includes a stage, a heater plate, a compression plate, a pair of clamping bases, a pair of extended blocks and a capillary. The heater plate is disposed on the stage. The compression plate arranged above the heater plate is able to move upward or downward for compressing the carrier. The clamping bases are arranged at two opposite sides of the compression plate, wherein the length of the compression plate does not match with the distance between the clamping bases. A pair of extended blocks is connected to a pair of clamping bases at one end, respectively, and connected to the compression plate at the other. The capillary is arranged above the compression plate for forming the bonding wires electrically connecting the chip and the carrier.

### CROSS-REFERENCE TO RELATED APPLICATION

This application claims the priority benefit of Taiwan application serial no. 95131320, filed on Aug. 25, 2006. All disclosure of the Taiwan application is incorporated herein by reference.

### BACKGROUND OF THE INVENTION

1. Field of the Invention

The present invention generally relates to a wire bonder, and more particularly, to a wire bonder having a pair of extended blocks for connecting a compression plate and a pair of clamping bases thereof.

2. Description of Related Art

Chips fabricated by semiconductor process need to be electrically connected to their carriers by wire bonding or other methods, to make them electrically connected to other electronic components through bonding wires.

FIG. 1 is a schematic side view showing a conventional wire bonder. Referring to FIG. 1, the conventional wire bonder 100 mainly comprises a stage 110, a heater plate 120, a compression plate 130, a pair of clamping bases 140, a pair of adapters 150 and a capillary 160.

The heater plate 120 disposed on the stage 110 is used for heating a lead frame 200 and gold lines. The compression plate 130 disposed on the heater plate 120 is able to move upward or downward, such that a carrier 200 disposed on the heater plate 120 may be clamped and fixed by the compression plate 130 and the heater plate 120. Besides, the compression plate 130 has an opening 132 for exposing the bonding pads (not shown herein) of the carrier 200 and a chip 210 disposed thereon. The clamping bases 140 are arranged at two opposite sides of the compression plate 130. The adapter 150 is disposed between the compression plate 130 and the clamping base 140. The adapter 150 has a tenon such that one side of the compression plate 130 is fixed in the adapter 150 by the tenon. The adapter 150 is screwed to the clamping base 140 by three screws 152 (only one screw is shown in FIG. 1). The capillary 160 is disposed above the compression plate 130 for forming a plurality of bonding wires 200 electrically connecting the chip 210 and the carrier 200.

Since the working areas of different types of wire bonders are different, the lengths of the compression plates for those wire bonders are different, too. If the wire bonders are to be upgraded, the original compression plates can not be use again, thus causing a waste of money.

Besides, the adapter 150 is screwed to the clamping base 140 through the screws 152, and therefore the adapter 150 may has a horizontal or vertical displacement. Then, the uneven vertical compression force exerted on the compression plate 130 may affect the yield rate of the wire bonding process.

Further, the wire bonder 100 utilizes the three screws 152 to make the adapter 150 screwed onto the clamping base 140. Therefore, it needs more components to assemble the adapter 150 and the clamping base 140 together, and the assembly time is longer.

### SUMMARY OF THE INVENTION

Accordingly, the present invention is directed to a wire bonder, wherein a compression plate of the wire bonder is fixed onto a clamping base through an extended block. Therefore, the compression plate may be applied to different types of wire bonders by using the extended blocks of different lengths.

The present invention is directed to a wire bonder suitable for wire bonding a chip disposed on a carrier to a plurality of bonding pads of the carrier. The wire bonder comprises a stage, a heater plate, a compression plate, a pair of clamping bases, a pair of extended blocks and a capillary. The heater plate is disposed on the stage. The compression plate is able to move upward or downward relative to the heater plate for compressing the carrier disposed on the heater plate. The compression plate has an opening for exposing the chip disposed on the carrier and the bonding pads of the carrier. The clamping bases are disposed at two opposite sides of the compression plate, wherein a length of the compression plate does not match with a distance between the clamping bases. Each of the extended blocks is connected between one of the clamping bases and the compression plate. The capillary is disposed above the compression plate for forming a plurality of bonding wires electrically connecting the chip and the bonding pads of the carrier.

According to an embodiment of the present invention, each of the extended blocks has a Z-shaped cross-section.

According to an embodiment of the present invention, one end of each extended block has a through hole for a screw to pass through, such that the extended block is screwed to the compression plate by the screw and the other end of each extended block is fixed on the clamping base by a mortise-and-tenon joint.

According to an embodiment of the present invention, both ends of each extended block have a first through hole and a second through hole for a first screw and a second screw to pass through, respectively, such that the extended block is screwed to the compression plate by the first screw, and the extended block is screwed to the clamping base by the second screw.

According to an embodiment of the present invention, each of the extended blocks has a Y-shaped cross-section.

According to an embodiment of the present invention, each of the extended blocks has a clamping portion and a fixing portion connected to the clamping portion. The clamping portion has a groove for clamping and fixing one side of the compression plate, and the fixing portion is fixed on the clamping base.

According to an embodiment of the present invention, the clamping portion of the extended block has a through hole for a screw to pass through, such that the extended block is screwed to the compression plate by the screw and the fixing portion of the extended block is fixed on the clamping base by a mortise-and-tenon joint.

According to an embodiment of the present invention, the clamping portion and the fixing portion of the extended block have a first through hole and a second through hole for a first screw and a second screw to pass through, respectively. Therefore, the extended block is screwed to the compression plate by the first screw, and the extended block is screwed to the clamping base by the second screw.

In the present invention, a pair of extended blocks is connected to a pair of clamping bases at one end, respectively, and connected to the compression plate at the other. Therefore, the compression plate of the same size cooperating with the extended blocks of different sizes may be applied to different types of wire bonders. Accordingly, when the wire bonders are upgraded, the compression plate cooperating with different sizes of the extended blocks may be reused, to avoid the waste of money.

Further, since the extended block is connected between the clamping base and the compression plate by using a mortise-and tenon joint or a screw, the extended block may not have a horizontal or vertical displacement compared with the prior art. The vertical compression force exerted on the compression plate is more uniform, and thus the yield rate of the wire bonding process may be enhanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic side view showing a conventional wire bonder.

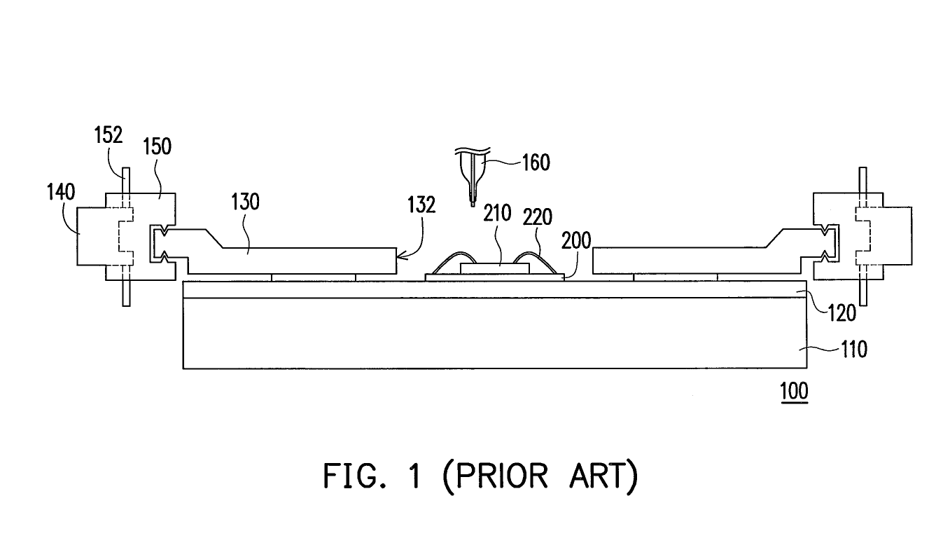

FIG. 2 is a schematic side view showing a wire bonder according to a first embodiment of the present invention.

FIG. 3 is a schematic side view showing a wire bonder according to a second embodiment of the present invention.

FIG. 4 is a schematic side view showing a wire bonder according to a third embodiment of the present invention.

FIG. 5 is a schematic side view showing a wire bonder according to a fourth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

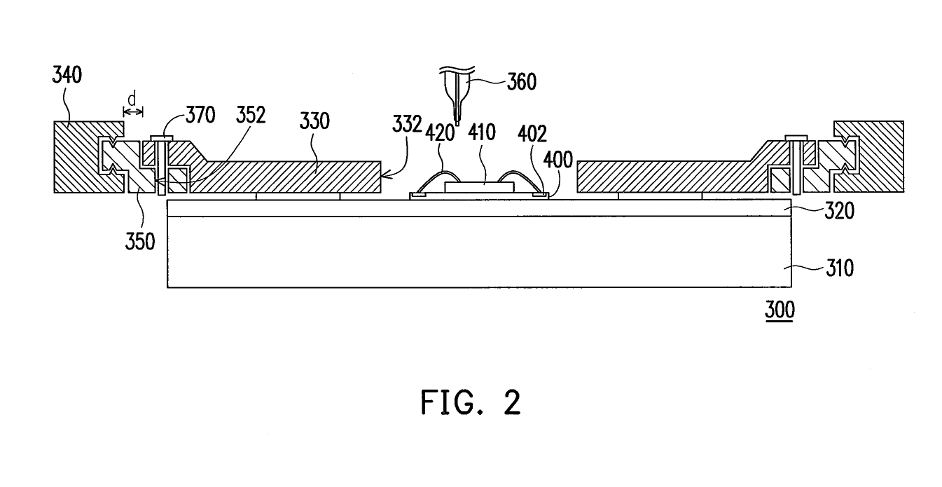

FIG. 2 is a schematic side view showing a wire bonder according to a first embodiment of the present invention. Please refer to FIG. 2, the wire bonder 300 of the present invention is suitable for wire bonding a plurality of bonding pads 402 of a carrier 400 and a chip 410 disposed thereon, such that the carrier 400 may be electrically connected to the chip 410 through a plurality of bonding wires 420.

The wire bonder 300 comprises a stage 310, a heater plate 320, a compression plate 330, a pair of clamping bases 340, a pair of extended blocks 350 and a capillary 360. The heater plate 320 is disposed on the stage 310. When a wire bonding process is performed, the heater plate 320 is used to heat the carrier 400 and the gold wire within the capillary 360. The compression plate 330 is able to move upward or downward relative to the heater plate 320 for compressing the carrier disposed on the heater plate. When the wire bonding process is performed, the compression plate 330 is raised and the heater plate 320 is lowered in order to clamp and fix the carrier 400, such that the carrier 400 would not be shacked during the wire bonding process. Besides, the compression plate 330 has an opening 332 such that a portion of the carrier and the chip 410 disposed on the carrier 400 are exposed from the opening 332 to perform the wire bonding process.

A pair of clamping bases 340 is disposed at the right side and the left side of the compression plate 330, respectively, and a length of the compression plate 330 does not match with a distance between the clamping bases 340. It means that a distance d exists between one of the clamping bases 340 and the periphery of the compression plate 330. A pair of extended blocks 350 is connected to a pair of clamping bases 340 at one end, respectively, and connected to the compression plate 330 at the other. The length of the extended block 350 is corresponding to the above-mentioned distance d. In this embodiment, each of the extended blocks 350 has a Z-shaped cross-section. One end of each extended block 350 near the compression plate 330 has a through hole 352 for a screw 370 to pass through, such that the extended block 350 is screwed to the compression plate 330 by the screw 370 and the other end of each of the extended block 350 is fixed on the clamping base 340 by a mortise-and-tenon joint. Therefore, the problem of a horizontal or vertical displacement of the adapter fixed on the clamping base by using three screws may be resolved. However, both ends of each of the extended blocks 350 may be fixed on the compression plate 330 and the clamping base 340, respectively, through other mechanisms, and it is not limited in the present invention.

The capillary 360 is disposed above the compression plate 330. When the wire bonding process is performed, a plurality of bonding wires 420 are formed by the capillary 360 for electrically connecting the chip 410 and the bonding pads 402 of the carrier 400.

The extended block 350 is fixed in the clamping base 340 through the mortise-and-tenon joint, and the extended block 350 would not have a horizontal or vertical displacement. Accordingly, the vertical compression force exerted on the compression plate 330 may be more uniform, and the yield rate of the wire bonding process may be improved. Moreover, the compression plate 330 cooperating with the extended block 350 of different lengths may be applied to different types of wire bonders.

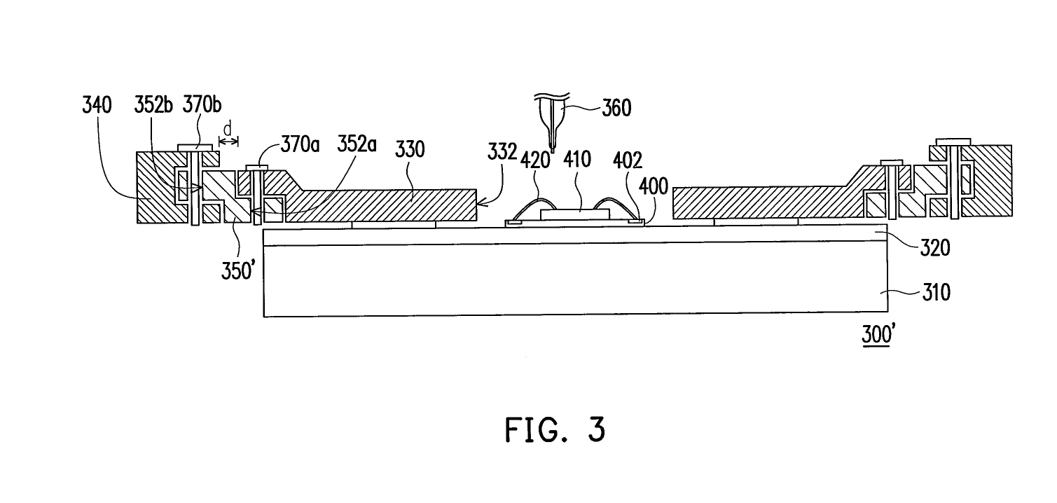

FIG. 3 is a schematic side view showing a wire bonder according to a second embodiment of the present invention. Please refer to FIG. 3, the structure of the wire bonder 300′ is similar to that of the wire bonder 300 as shown in FIG. 2, and the difference between them is that both ends of each of the extended blocks 350′ have a first through hole 352a and a second through hole 352b for a first screw 370a and a second screw 370b to pass through, respectively, such that one end of each of the extended blocks 350′ is screwed to the compression plate 330 by the first screw 370a, and the other end of each of the extended blocks 350′ is screwed to the clamping base 340 by the second screw 370b.

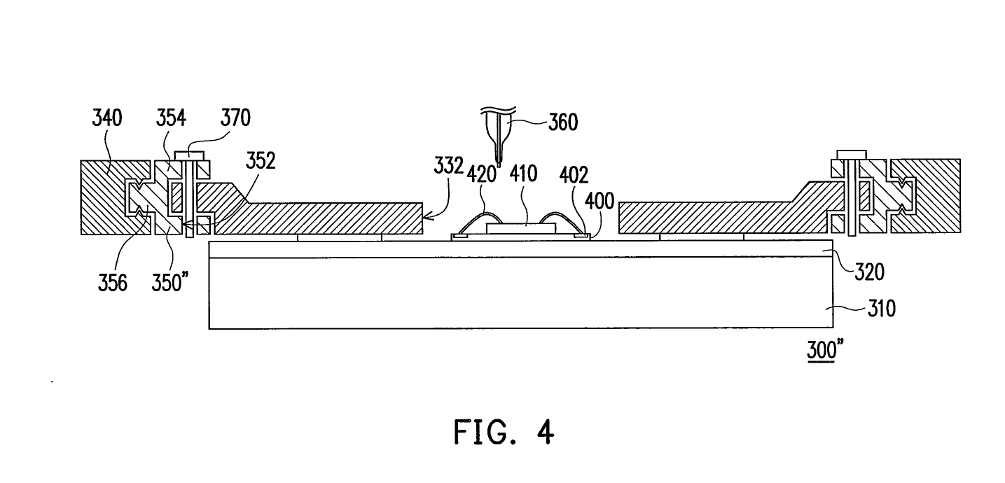

FIG. 4 is a schematic side view showing a wire bonder according to a third embodiment of the present invention. Referring to FIG. 4, the structure of the wire bonder 300″ is similar to that of the wire bonder 300 as shown in FIG. 2, and the difference between them is that the extended block 350″ has a Y-shaped cross-section, and it comprises a clamping portion 354 and a fixing portion 356 connected to the clamping portion 354. The clamping portion 354 has a groove 354a for clamping and fixing one side of the compression plate 330, and the fixing portion 356 is fixed in the clamping base 340. In this embodiment, the clamping portion 354 of the extended block 350″ has a through hole 352 for a screw 370 to pass through, such that the extended block 350″ is screwed onto the compression plate 330 by the screw 370, and the fixing portion 356 of the extended block 350″ is fixed in the clamping base 340 by using a mortise-and-tenon joint. Since the compression plate 330 is firmly clamped in the extended block 350″ having a Y-shaped cross-section, the carrier 400 would not shift during the wire bonding process. Accordingly, the yield rate of the wire bonding process may be enhanced.

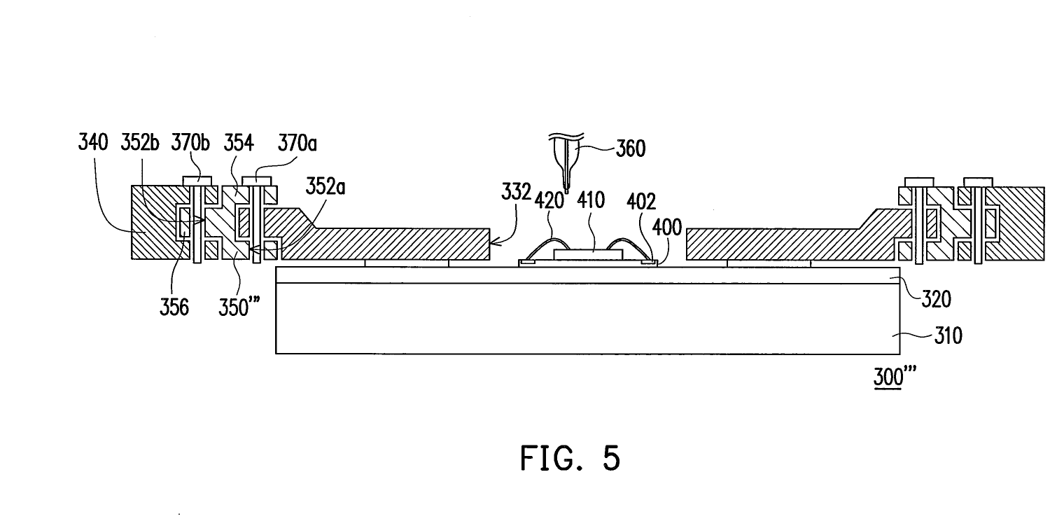

FIG. 5 is a schematic side view showing a wire bonder according to a fourth embodiment of the present invention. Referring to FIG. 5, the structure of the wire bonder 300′″ is similar to that of the wire bonder 300″ as shown in FIG. 4, and the difference between them is that the clamping portion 354 and the fixing portion 356 have a first through hole 352a and a second through hole 352b for a first screw 370a and a second screw 370b to pass through, respectively, such that one end of the extended block 350′″ is screwed to the compression plate 330 by the first screw 370a and the other end of the extended block 350′″ is screwed to the clamping base 340 by the second screw 370b.

In summary, in the wire bonder of the present invention, a pair of extended blocks is used to be connected to a pair of clamping bases at one end, respectively, and be connected to the compression plate at the other. Therefore, the compression plate of the same size cooperating with the extended blocks of different sizes may be applied to different types of wire bonders. Accordingly, when the wire bonders are upgraded, the compression plate cooperating with different sizes of the extended blocks may be reused, to avoid the waste of money.

Further, since the extended block is connected between the clamping base and the compression plate by using a mortise-and tenon joint or a single screw, the extended block may not have a horizontal or vertical displacement compared with the prior art. Then, the vertical compression force exerted on the compression plate is more uniform, and thus the yield rate of the wire bonding process may be enhanced.

Moreover, one end of the extended block is fixed in the clamping base by a mortise-and-tenon joint, and the other end of the extended block is fixed on the compression plate by a single screw or a mortise-and-tenon joint. Compared with the prior art, the wire bonder of the present invention requires fewer components for assembling the compression plate and the clamping bases together, and the assembly time is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wire bonder, suitable for wire bonding a chip disposed on a carrier to a plurality of bonding pads of the carrier, the wire bonder comprising:
a stage;
a heater plate, disposed on the stage;
a compression plate, being able to move upward or downward relative to the heater plate for compressing the carrier disposed on the heater plate, wherein the compression plate has an opening for exposing the chip disposed on the carrier and the bonding pads of the carrier;
a pair of clamping bases, disposed at two opposite sides of the compression plate, wherein a length of the compression plate does not match with a distance between the clamping bases;
a pair of extended blocks, wherein each of the extended blocks is connected between one of the clamping bases and the compression plate; and
a capillary, disposed above the compression plate for forming a plurality of bonding wires electrically connecting the chip and the bonding pads of the carrier.

2. The wire bonder according to claim 1, wherein each of the extended blocks has a Z-shaped cross-section.

3. The wire bonder according to claim 2, wherein one end of each extended block has a through hole for a screw to pass through, such that the extended block is screwed to the compression plate by the screw and the other end of each extended block is fixed on the clamping base by a mortise-and-tenon joint.

4. The wire bonder according to claim 2, wherein both ends of each extended block have a first through hole and a second through hole for a first screw and a second screw to pass through, respectively, such that the extended block is screwed to the compression plate by the first screw, and the extended block is screwed to the clamping base by the second screw.

5. The wire bonder according to claim 1, wherein each of the extended blocks has a Y-shaped cross-section.

6. The wire bonder according to claim 5, wherein each of the extended blocks has a clamping portion and a fixing portion connected to the clamping portion, the clamping portion has a groove for clamping and fixing one side of the compression plate, and the fixing portion is fixed on the clamping base.

7. The wire bonder according to claim 6, wherein the clamping portion of the extended block has a through hole for a screw to pass through, such that the extended block is screwed to the compression plate by the screw and the fixing portion of the extended block is fixed on the clamping base by a mortise-and-tenon joint.

8. The wire bonder according to claim 6, wherein the clamping portion and the fixing portion of the extended block have a first through hole and a second through hole for a first screw and a second screw to pass through, respectively, such that the extended block is screwed to the compression plate by the first screw, and the extended block is screwed to the clamping base by the second screw.
